(19) United States
(12) Patent Application Publication
(10) Pub. No.: US 2013/0137327 A1
(43) Pub. Date: May 30, 2013

(54) ANTI-INTERFERENCE COVER MADE OF A COMPOUND MATERIAL FOR AN ELECTRONIC PRODUCT

(71) Applicant: KAI-HSI TSENG, CHANGHUA COUNTY (TW)

(72) Inventor: KAI-HSI TSENG, CHANGHUA COUNTY (TW)

(21) Appl. No.: 13/304,452

(22) Filed: Nov. 25, 2011

(51) Int. Cl. D03D 15/00; B32B 15/02; B32B 17/02

(52) U.S. Cl. 442/229; 442/301

(57) ABSTRACT

An anti-interference cover made of a compound material for an electronic product has a fiber fabric. The fiber fabric is made of a compound material to take the form of a case, and has at least one unblocking area, each one of the at least one unblocking area having multiple non-conductive fibers interwoven and aligned longitudinally and transversely, and multiple conductive fibers interwoven and aligned longitudinally and transversely and not covered by the at least one unblocking area. When the cover is assembled with an electronic product, the at least one unblocking area of the cover allows electromagnetic wave transmitted and received by communication components to pass therethrough, thereby preventing blocking signals and providing a cover with high strength, thin profile and light weight.

### BACKGROUND OF THE INVENTION

1. Field of the Invention

The present invention relates to a cover made of a compound material for an electronic product, and more particularly to an anti-interference cover made of a compound material for an electronic product.

2. Description of the Related Art

To pursue value-added features to have light weight, thin profile, high strength and the like, electronic products, such as mobile phones, employ compound material, such as carbon fiber, to build covers thereof, thereby reducing the weight and thickness of the mobile phones and raising the quality and value of the electronic products.

As carbon fiber is conductive, covers formed by carbon fiber fabric in a hardening process are also conductive. When electromagnetic signals of mobile phone pass through those conductive covers, the signals are blocked or interfered. The received signals are weak and thus require higher signal strength to pass through the covers. Such covers certainly cause operational inconvenience to users of the mobile phones.

### SUMMARY OF THE INVENTION

An objective of the present invention is to provide an anti-interference cover made of a compound material for an electronic product.

To achieve the foregoing objective, the anti-interference cover has a fiber fabric.

The fiber fabric is made of a compound material to take the form of a case, and has at least one unblocking area and multiple conductive fibers.

Each one of the at least one unblocking area has multiple non-conductive fibers interwoven and aligned longitudinally and transversely.

The conductive fibers are interwoven and aligned longitudinally and transversely, and are not covered by the at least one unblocking area.

When the anti-interference cover is assembled with an electronic product, as each one of the at least one unblocking area has only non-conductive fibers interwoven within the unblocking area, the unblocking area is non-conductive and can prevent blocking the electromagnetic waves transmitted or received by communication components inside the electronic product. Accordingly, besides providing a cover made of a compound material for an electronic product with high strength, thin profile and light weight, the present invention can also prevent communication signals of the electronic product from being affected.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a mobile phone having a first embodiment of an anti-interference cover made of a compound material in accordance with the present invention;

FIG. 2 is a perspective view of the mobile phone having the anti-interference cover in FIG. 1;

FIG. 3 is a perspective view of the anti-interference cover in FIG. 1;

FIG. 4 is a perspective view of a tablet personal computer having a second embodiment of an anti-interference cover made of a compound material in accordance with the present invention;

FIG. 5 is another perspective view of the tablet personal computer having the anti-interference cover in FIG. 4; and

FIG. 6 is a perspective view of a notebook computer having a third embodiment of an anti-interference cover made of a compound material in accordance with the present invention.

### DETAILED DESCRIPTION OF THE INVENTION

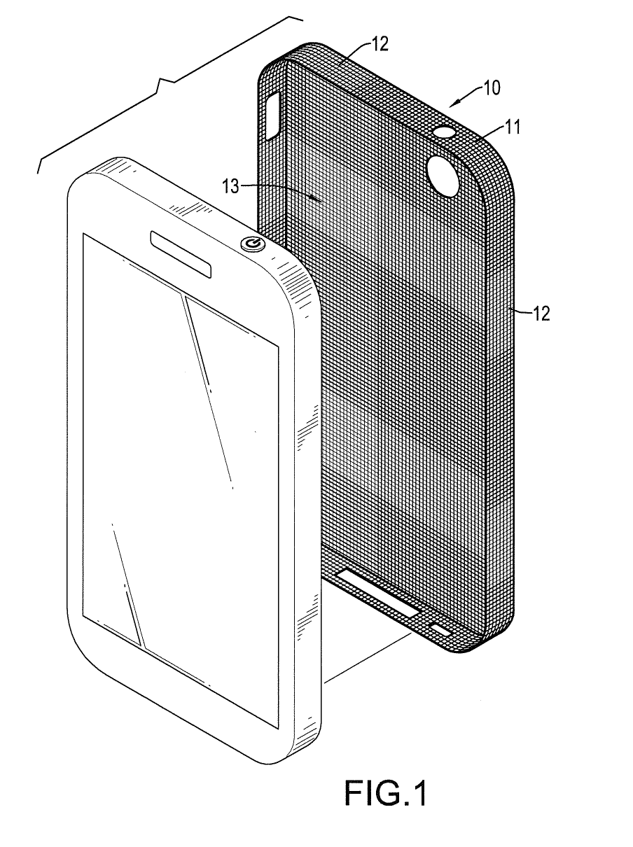

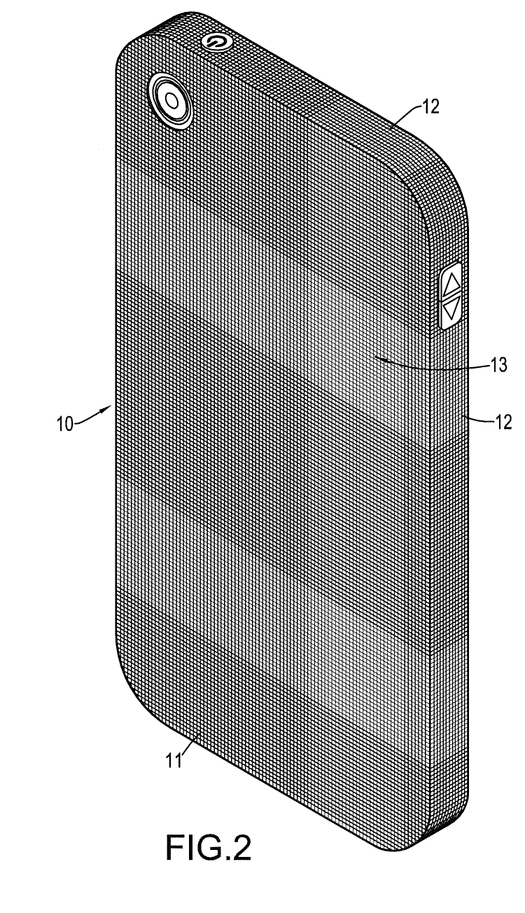

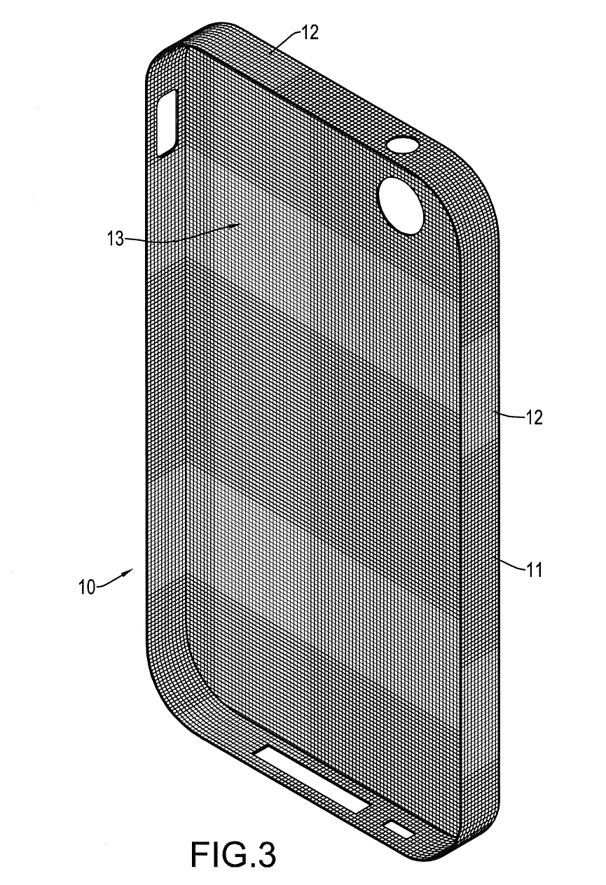

With reference to FIGS. 1 to 3, a first embodiment of an anti-interference cover made of a compound material for an electronic product in accordance with the present invention has a fiber fabric 10. The fiber fabric 10 is made of a compound material, may be immersed in a resin bath and is pressed and hardened with the resin coated thereon to take the form of a case. The fiber fabric 10 may have multiple fibers interwoven and aligned longitudinally and transversely to take the form of a case.

In the present embodiment, the fiber fabric 10 takes the form of a mobile phone case. The fiber fabric 10 has multiple conductive fibers 11 interwoven and aligned longitudinally and transversely. In the present embodiment, the conductive fibers 11 are carbon fibers. The conductive fibers 11 may be metal fibers. Alternatively, the fiber fabric 10 may have multiple non-conductive fibers 12 interwoven and aligned longitudinally and transversely, and the non-conductive fibers 12 may be organic fibers and inorganic fibers having high strength and high ductility, such as polyethylene terephthalate (PET) fibers, polyester (PE) fibers, polypropylene (PP) fibers, Kevlar fibers, aramid fibers, para aramid fibers, glass fibers and basalt fibers. In consideration of the requirements for the communication components to transmit and receive signals through the fiber fabric 10, the fiber fabric 10 has two unblocking areas 13 formed thereon for signals to be transmitted and received therethrough. Each unblocking area 13 is rectangular and is formed by multiple non-conductive fibers 12 interwoven and aligned longitudinally and transversely. The conductive fibers 11 are formed on other areas of the fiber fabric 10 not covered by the unblocking areas 13.

Besides having two unblocking areas 13 in the present embodiment, the fiber fabric 10 may be customized to have more or less unblocking area 13 depending on the number of areas required to unblock electromagnetic wave transmitted and received by a mobile phone.

As the unblocking area 13 has only non-conductive fibers formed thereon, the unblocking area 13 is therefore non-conductive so as to prevent interfering or blocking electromagnetic wave transmitted or received by communication components inside a mobile phone. As a result, the present invention not only provides the cover made of a compound material with high strength, high wear resistance and light weight, but also prevents signals of a mobile phone in communication from being affected.

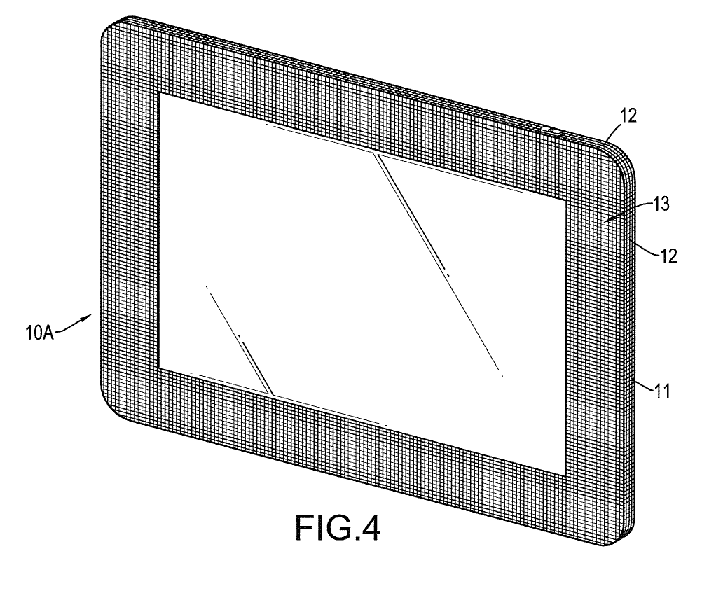

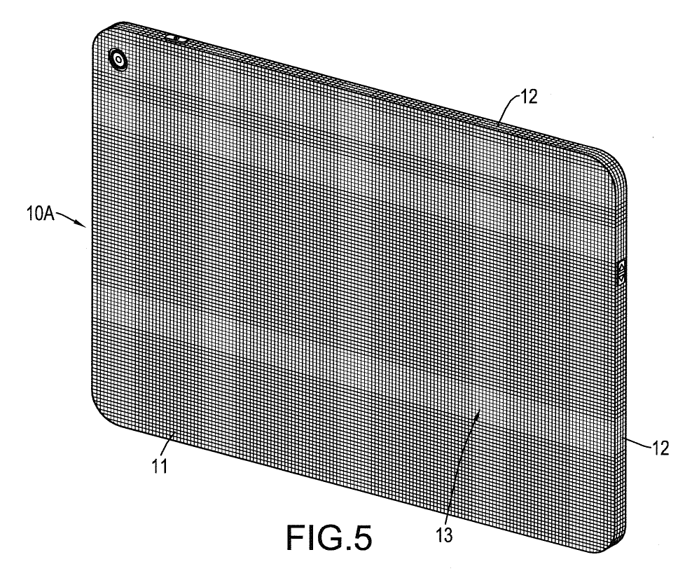

With reference to FIGS. 4 to 5, a second embodiment of an anti-interference cover made of a compound material for an electronic product in accordance with the present invention respectively serve as a case of a tablet personal computer and has a fiber fabric 10A. The fiber fabric 10A is made of a compound material, is immersed in the resin, and is pressed and hardened with the resin coated thereon to take the form of a case.

In the present embodiment, the fiber fabric 10A takes the form of a case of a tablet personal computer. The fiber fabric 10A has multiple conductive fibers 11 interwoven and aligned longitudinally and transversely. In the present embodiment, the conductive fibers 11 are carbon fibers or metal fibers. Alternatively, the fiber fabric 10A may have multiple non-conductive fibers 12 interwoven and aligned longitudinally and transversely, and the non-conductive fibers 12 may be plastic materials and glass fibers. In consideration of the requirements for the communication components to transmit and receive signals through the fiber fabric 10A, the fiber fabric 10A has multiple unblocking areas 13 formed thereon for signals to be transmitted and received therethrough. Each unblocking area 13 is rectangular and is formed by multiple non-conductive fibers 12 interwoven and aligned longitudinally and transversely. The conductive fibers 11 are formed on other areas of the fiber fabric 10A not covered by the unblocking areas 13.

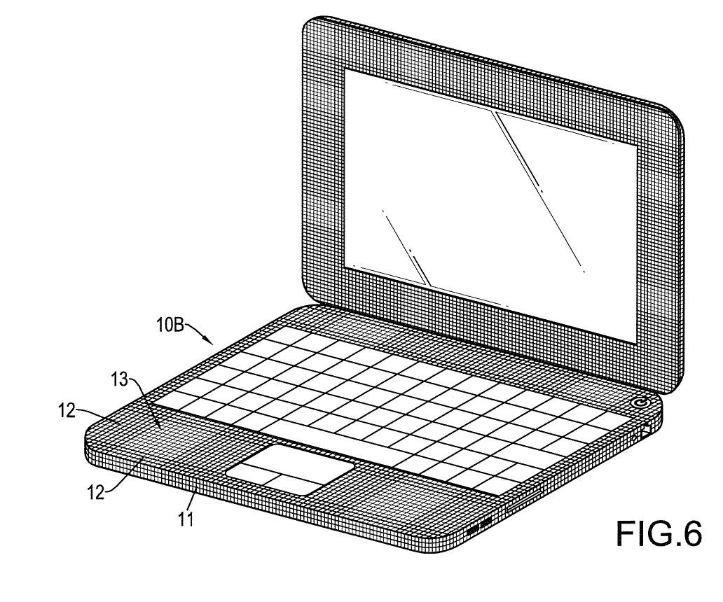

With reference to FIG. 6, a third embodiment of an anti-interference cover made of a compound material for an electronic product in accordance with the present invention respectively serve as a case of a notebook computer and has resin and a fiber fabric 10B. The fiber fabric 10B is made of a compound material, is immersed in a resin bath and is pressed and hardened with the resin coated thereon to take the form of a case.

In the present embodiment, the fiber fabric 10B takes the form of a case of a notebook computer. The fiber fabric 10B has multiple conductive fibers 11 interwoven and aligned longitudinally and transversely. In the present embodiment, the conductive fibers 11 are carbon fibers or metal fibers. Alternatively, the fiber fabric 10B may have multiple non-conductive fibers 12 interwoven and aligned longitudinally and transversely, and the non-conductive fibers 12 may be organic fibers and inorganic fibers having high strength and high ductility, such as polyethylene terephthalate (PET) fibers, polyester (PE) fibers, polypropylene (PP) fibers, Kevlar fibers, aramid fibers, para aramid fibers, glass fibers and basalt fibers. In consideration of the requirements for the communication components to transmit and receive signals through the fiber fabric 10B, the fiber fabric 10B has multiple unblocking areas 13 formed thereon for signals to be transmitted and received therethrough. Each unblocking area 13 is rectangular and is formed by multiple non-conductive fibers 12 interwoven and aligned longitudinally and transversely. The conductive fibers 11 are formed on other areas of the fiber fabric 10B not covered by the unblocking areas 13.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A n anti-interference cover made of a compound material for an electronic product, comprising:
a fiber fabric made of a compound material to take the form of a case, and having:
at least one unblocking area, each one of the at least one unblocking area having multiple non-conductive fibers interwoven and aligned longitudinally and transversely; and
multiple conductive fibers interwoven and aligned longitudinally and transversely, and not covered by the at least one unblocking area.

2. The anti-interference cover as claimed in claim 1, wherein the conductive fibers are carbon fibers.

3. The anti-interference cover as claimed in claim 1, wherein the conductive fibers are metal fibers.

4. The anti-interference cover as claimed in claim 1, wherein the non-conductive fibers are chemical fibers.

5. The anti-interference cover as claimed in claim 2, wherein the non-conductive fibers are chemical fibers.

6. The anti-interference cover as claimed in claim 3, wherein the non-conductive fibers are chemical fibers.

7. The anti-interference cover as claimed in claim 1, wherein the non-conductive fibers are glass fibers.

8. The anti-interference cover as claimed in claim 2, wherein the non-conductive fibers are glass fibers.

9. The anti-interference cover as claimed in claim 3, wherein the non-conductive fibers are glass fibers.
